(19) United States
(12) Patent Application Publication
(10) Pub. No.: US 2026/0035812 A1
(43) Pub. Date: Feb. 5, 2026

(54) ALKALINE ELECTROLYTE REGENERATION

(71) Applicant: PHINERGY LTD., Kfar Saba (IL)

(72) Inventors: Ilya YAKUPOV, Rehovot (IL); Aviel DANINO, Ariel (IL); Mark WEAVER, Greenwell Springs, LA (US); Sean Henry GALLAGHER, Pittsburgh, PA (US); Nicola MENEGAZZO, Pittsburgh, PA (US)

(73) Assignee: PHINERGY LTD., Kfar Saba (IL)

(21) Appl. No.: 19/314,091

(22) Filed: Aug. 29, 2025

Related U.S. Application Data
(63) Continuation-in-part of application No. 17/413,976, now abandoned.
(60) Provisional application No. 62/782,630, filed on Dec. 20, 2018.

(51) Int. Cl. C25B 9/19; C25B 1/01; C25B 15/08; H01M 6/50; H01M 12/06

(52) U.S. Cl. CPC C25B 9/19; C25B 1/01; C25B 15/081; C25B 15/085; H01M 6/5077; H01M 12/06

(57) ABSTRACT

Methods and systems for electrolyte regeneration are provided, which regenerate a spent alkaline electrolyte (SE) comprising dissolved aluminum oxide hydrates from an aluminum-air battery, by electrolysis, to precipitate aluminum tri-hydroxide (ATH) and form regenerated alkaline electrolyte. A same-cation salt is added to an anolyte solution used in the electrolysis (and devoid of aluminates) to replenish a corresponding electrolyte cation and maintain the conditions for ATH precipitation. The regeneration may be carried out continuously, e.g., mixing the SE and the same-cation salt in a salt tank that delivers the anolyte solution, removing a portion of the regenerated alkaline electrolyte from a catholyte tank delivering the catholyte solution, and filtering the ATH from a solution delivered from the salt tank to the anolyte tank. Optionally, the salt may be a buffering salt, and in some cases chemical reactions may be used to enhance the regeneration by electrolysis.

### CROSS REFERENCE TO RELATED APPLICATIONS

This application is a Continuation-in-Part of U.S. patent application Ser. No. 17/413,976, filed Jun. 15, 2021, which claims the benefit of WIPO Application No. PCT/IL2019/051349, filed on Dec. 10, 2019, which claims the benefit of U.S. Provisional Application No. 62/782,630, filed on Dec. 20, 2018. The prior applications are incorporated herein by reference in their entirety.

### BACKGROUND

### 1. Technical Field

The present invention relates to the field of electrolyte treatment, and more particularly, to regeneration of spent electrolyte, as product, e.g., of the operation of metal-air batteries or of other chemical processes.

### 2. Discussion of Related Art

Metal-air electrochemical power sources, particularly Al-air batteries and fuel cells with alkaline electrolytes, yield metal hydroxides (e.g., aluminum hydroxide) as a result of dissolution of the metal from the anode, which lowers the efficiency of the metal-air power sources and requires replacement of the electrolyte solution. Additionally, metal hydroxides are by-products of many useful chemical processes (e.g., the Bayer process of alumina production, dissolution of aluminum metal in alkali, e.g., for hydrogen production, aluminum anodizing process, etc. all produce alkali aluminate solution).

U.S. Pat. No. 9,711,804, which is incorporated herein by reference in its entirety, teaches regeneration of spent electrolyte solutions by membrane electrolysis by filling the spent electrolyte (K[Al(OH)₄]) into the anode compartment of the membrane electrolysis cell to form an anolyte solution, filling alkaline solution into the cathode compartment of the membrane electrolysis cell to form a catholyte solution, and passing an electric current through the membrane electrolysis cell to reduce the concentration of alkali hydroxide in the anolyte solution and to increase the concentration of alkali hydroxide in the catholyte solution.

U.S. Pat. No. 5,198,085, which is incorporated herein by reference in its entirety, teaches an electrodialytic process for insolubilization and separation of a metal hydroxide, such as aluminum hydroxide by feeding an alkali hydroxide solution comprising the metal hydroxide to an electrolyte in an electrodialytic process comprising a soluble anion of an acid or a soluble salt of an acid while passing electricity through the cell to remove alkali cations from the electrolyte at the rate alkali cations are fed to the electrolyte to effect and maintain the pH of the electrolyte whereby the metal hydroxide is insolubilized and separated from the electrolyte and the electrotransported alkali cations are converted to a solution of alkali hydroxide in the catholyte of the electrodialytic process. The aluminates' solution is acidified to the point where aluminum trihydroxide precipitates, and then electricity is passed, accompanied by feeding of corresponding flow of aluminate solution.

### SUMMARY

The following is a simplified summary providing an initial understanding of the invention. The summary does not necessarily identify key elements nor limit the scope of the invention, but merely serves as an introduction to the following description.

One aspect of the present invention provides a system comprising: (i) an electrolysis unit comprising an anode with anolyte solution and a cathode with catholyte solution, separated by a cation-selective separator, and a controller configured to carry out an electrolysis process in the electrolysis unit; (ii) a spent alkaline electrolyte (SE) supply configured to supply SE that comprises an electrolyte cation and dissolved aluminum oxide hydrates from an aluminum-air battery, to the anolyte solution, wherein the anolyte solution comprises a same-cation salt that includes the same electrolyte cation as in the SE and does not include aluminates, and is used to replenish the corresponding electrolyte cation, and wherein the electrolysis unit is configured to precipitate aluminum tri-hydroxide (ATH) and form regenerated alkaline electrolyte by electrolysis of the SE; (iii) an ATH collection unit configured to receive the precipitated ATH from the anolyte solution; and (iv) a regenerated electrolyte collection unit configured to receive the regenerated alkaline electrolyte from the catholyte solution.

One aspect of the present invention provides a method of operating the system, the method comprising: applying electrolysis to the SE in the electrolysis unit to precipitate the ATH and regenerating the alkaline electrolyte, and adding the same-cation salt to the anolyte solution used in the electrolysis to replenish the corresponding electrolyte cation, wherein the same-cation salt includes the same electrolyte cation as the SE and does not include aluminates.

These, additional, and/or other aspects and/or advantages of the present invention are set forth in the detailed description which follows: possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high-level schematic illustration of a system with an electrolysis unit for regenerating spent electrolyte, according to some embodiments of the invention.

FIGS. 2 and 3 are high-level schematic illustrations of systems for regenerating spent electrolyte, according to some embodiments of the invention.

FIG. 4 is a high-level schematic illustration of multi-cell systems for regenerating spent electrolyte by electrolysis, according to some embodiments of the invention.

FIG. 5 is a high-level schematic illustration of systems for regenerating spent electrolyte by electrolysis and chemically, according to some embodiments of the invention.

FIGS. 6A and 6B are examples for voltages across cell elements with an electrolysis cell operated according to some embodiments of the invention compared to prior art electrolysis, respectively.

FIG. 7 provides experimental data illustrating the dependence of the ATH precipitation on the pH, according to some embodiments of the invention.

FIG. 8 is a high-level flowchart illustrating a method, according to some embodiments of the invention.

It will be appreciated that for simplicity and clarity of illustration, elements shown in the Figures have not necessarily been drawn to scale. For example, the dimensions of some of the elements may be exaggerated relative to other elements for clarity. Further, where considered appropriate, reference numerals may be repeated among the Figures to indicate corresponding or analogous elements.

### DETAILED DESCRIPTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for regenerating spent electrolyte, and thereby provide improvements to the technological field of energy storage devices and in particular of metal-air batteries. Methods and systems for electrolyte regeneration are provided, which regenerate a spent alkaline electrolyte (SE) comprising dissolved aluminum oxide hydrates from an aluminum-air battery, by electrolysis, to precipitate aluminum tri-hydroxide (ATH) and form regenerated alkaline electrolyte. A same-cation salt is added to an anolyte solution used in the electrolysis (and devoid of aluminates) to replenish a corresponding electrolyte cation and maintain the conditions for ATH precipitation. The regeneration may be carried out continuously, e.g., mixing the SE and the same-cation salt in a salt tank that delivers the anolyte solution, removing a portion of the regenerated alkaline electrolyte from a catholyte tank delivering the catholyte solution, and filtering the ATH from a solution delivered from the salt tank to the anolyte tank. Optionally, the salt may be a buffering salt, and in some cases chemical reactions may be used to enhance the regeneration by electrolysis.

In various embodiments, spent electrolyte may be regenerated using an electrolysis process wherein salt is added to the anolyte solution. Specifically, alkaline solution may be separated and recovered from an aqueous aluminate solution by means of electrolysis-based methods. In certain embodiments, a membrane electrolysis cell which employs addition of salt to the anolyte solution may be used to recover alkaline solutions (e.g., potassium hydroxide or sodium hydroxide) from aqueous solutions of hydroxide complex anions that are soluble in an alkaline environment. For example, solutions were used which comprise hydroxide complex anions of the formula [M(OH)ₙ]^{-p}, wherein M indicates a metal, n is an integer equal to or greater than 3 and p is an integer equal to or greater than 1 (e.g., p equals 1 or 2). In certain embodiments, M indicates a metal which forms sparingly soluble or water insoluble hydroxide of the formula M(OH)ₘ (m<n). As non-limiting examples, alkali hydroxide solutions were recovered from alkali salts of anions of amphoteric hydroxides, such as the aluminate ion Al(OH)₄⁻, zincate ion Zn(OH)₄²⁻ and stannate ion Sn(OH)₆²⁻ (the corresponding amphoteric hydroxides are Al(OH)₃, Zn(OH)₂ and Sn(OH)₂, respectively). The hydroxide complex anions may be hydrated. However, for simplicity, water molecules are not indicated in the formulas presented herein. It is further notes that the term aluminum oxide hydrates is used herein in a broad sense to refer to aluminum hydroxide (Al(OH)₃), alumina hydrates (e.g., Al₂O₃·3H₂O) as well as aluminates such as potassium and sodium aluminates (e.g., K(Al(OH)₄), NaAlO₂, respectively, and hydrated forms thereof) formed in the electrolyte solution.

The experimental work reported herein indicates that when an electrical current was passed through a membrane electrolysis cell provided with a cathode and an anode and operating with K[Al(OH)₄] solution as the anolyte solution, KOH as the catholyte solution and wherein potassium-containing salt is added to the anolyte solution, Al(OH)₃ (ATH) precipitates from the anolyte solution, while potassium ions continually migrate from the anode side across the cation exchange membrane (or separator) to the cathode side, potassium hydroxide solution is progressively formed and collected on the cathodic side of the cell. On reaching sufficiently high concentrated potassium hydroxide solution, for example, with a concentration of not less than 5%, the catholyte solution was removed from the cell and recycled to a reservoir of a metal-air battery.

Cathodes may comprise conventional cathodes or oxygen-consuming cathodes. For example, using a conventional cathode in an electrolysis cell that evolves hydrogen, the reactions on the cathode and on the anode are as follows (with respect to a standard hydrogen electrode—SHE):

| | | |
|---|---|---|
| On the cathode: | 4H₂O + 4e⁻ -> 2H₂ + 4OH⁻ | (E₀ = 0.83 V vs. SHE) |
| On the anode: | 4OH⁻ -> O₂ + 2H₂O + 4e⁻ | (E₀ = −0.40 V vs. SHE), |

and the theoretical voltage is: 1.23V. When the hydrogen evolution cathode is replaced by an oxygen-consuming cathode, the reactions on the cathode and on the anode are:

| | | |
|---|---|---|
| On the cathode: | O₂ + 2H₂O + 4e⁻ -> 4OH⁻ | (E₀ = +0.40 V vs. SHE) |
| On the anode: | 4OH⁻ -> O₂ + 2H₂O + 4e⁻ | (E₀ = −0.40 V vs. SHE). |

For both cells described above, in the anolyte tank, aluminum hydroxide precipitates:

$${[ {Al ( OH )}_{4} ]}_{( aq )}^{-} \to {Al ( OH )}_{3 ( s )} + {OH}_{( aq )}^{-}$$

Disclosed methods comprise of passing an electric current through a membrane electrolysis cell provided with an anode and a cathode, wherein the anolyte solution of the cell contains an alkali salt of hydroxide complex anion, and a salt comprising the same alkali cation as the alkali cation in the alkali salt of hydroxide complex anion. Operating the cell according to disclosed methods, causes reduction of the concentration of alkali hydroxide in the anolyte solution and an increase of the concentration of alkali hydroxide in the catholyte solution. These concentration changes are the result of the current passage through the cell. The hydroxide complex anion is typically of the formula [M(OH)ₙ]^{-p}, namely. [M(OH)ₙ]⁻¹ or [M(OH)ₙ]⁻², wherein M is a multivalent metal cation (such as Al⁺³ or Zn⁺²) and n is an integer equal to or greater than 3 and p may be 1 or 2. In certain embodiments, the increase of the alkali hydroxide concentration in the catholyte solution yields a concentrated alkali hydroxide solution in the catholyte solution. The concentrated alkali hydroxide solution generated at the cathode compartment of the membrane electrolysis cell may be usable as an electrolyte for metal-air batteries. Elemental oxygen evolving at the anode side of the membrane electrolysis cell may be supplied to the outer face of the oxygen-consuming cathode. In certain embodiments, the anolyte solution may be supplied from an electrolyte reservoir of a metal-air battery; and the concentration of the catholyte solution may gradually increase to form a concentrated alkali hydroxide solution; and at least a portion of the resultant concentrated alkali hydroxide solution may be added to an electrolyte of a metal-air battery.

Disclosed embodiments maintain the low pH of the anolyte solution to promote precipitation of the aluminum hydroxides, while compensating for the resulting movement of the cations into the catholyte as a result of the low pH—by adding same-cation salt into the anolyte solution. Disclosed embodiments thereby improve the process efficiency, allow complete regeneration of SE, and maintain an advantageous gradient of cations across the membrane throughout the whole process.

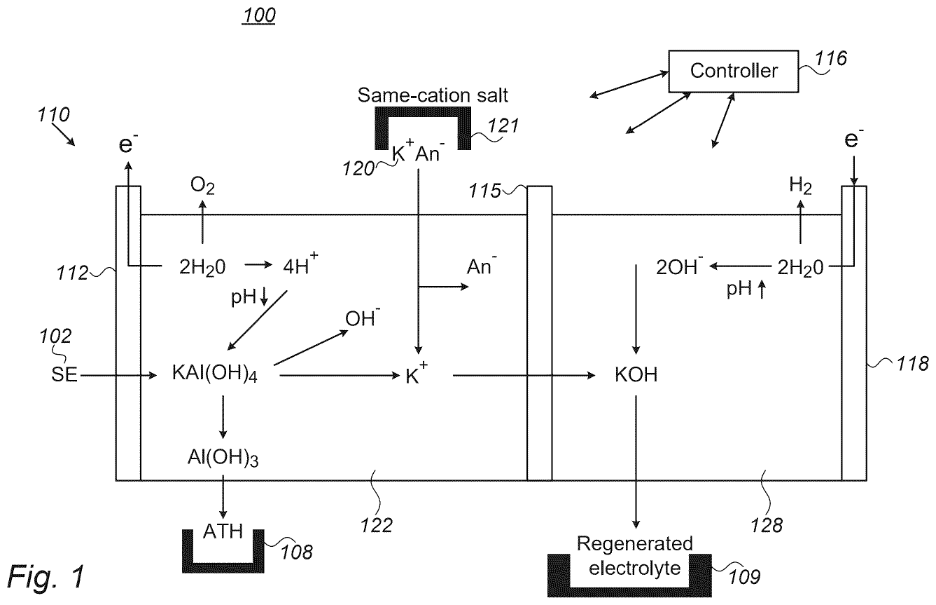

FIG. 1 is a high-level schematic illustration of a system 100 with an electrolysis unit 110 for regenerating spent electrolyte, according to some embodiments of the invention. Electrolysis unit 110 may comprise an anode 112 with anolyte solution 122 and a cathode 118 with catholyte solution 128, separated by a cation-selective separator 115, and a controller 116 configured to carry out an electrolysis process in electrolysis unit 110. System 100 further comprises a spent alkaline electrolyte (SE) supply 102 configured to supply SE to anolyte solution 122. The SE comprises an electrolyte cation (e.g., K⁺, Na⁺ and/or Li⁺) and dissolved aluminum oxide hydrates, received from aluminum-air battery(ies). Anolyte solution 122 comprises a same-cation salt that includes the same electrolyte cation (e.g., K⁺, Na⁺ and/or Li⁺) as in the SE and does not include aluminates, and is used to replenish the corresponding electrolyte cation. Electrolysis unit 110 is configured to precipitate aluminum tri-hydroxide (ATH) and form regenerated alkaline electrolyte by electrolysis of the SE. Solutions including the ATH and the regenerated alkaline electrolyte may be removed from electrolysis unit 110 for collection and further processing as described herein be various means of fluid deliver such as conduits and/or pumps, which are not specifically described herein to maintain simplicity.

System 100 further comprises an ATH collection unit 108 configured to receive the precipitated ATH from anolyte solution 122 and optionally filter ATH therefrom, and a regenerated electrolyte collection unit 109 configured to receive the regenerated alkaline electrolyte from catholyte solution 128. Controller 116 may be configured to receive and send information and control commands, respectively, from any of the elements in system 100, as illustrated schematically by the double-headed arrows, and fluid handling network components (not explicitly illustrated) are part of system 100. For example, controller 116 may be configured to control any of electrolysis unit 110 with respect to its operation parameters, as well as SE supply 102, ATH collection unit 108 and regenerated electrolyte collection unit 109 and a salt unit 121 (see below) with respect to their providing and collection of respective materials.

The electrolyte regeneration process is illustrated using potassium (K⁺) as a non-limiting example for the cation involved. SE 102 in anolyte solution 122 comprises KAl(OH)₄ which is typically in solution at high pH of e.g., ca. 12-14. Upon operation of electrolysis unit 110, protons are released into anolyte solution 122 (2H₂O→O₂+4H⁺), reducing the pH and precipitating ATH (Al(OH)₃) at lower pH of typically 10-11. Released cations, e.g., K⁺ move along the concentration gradient to catholyte solution 128, from which electrolyte (e.g., KOH) is regenerated.

In various embodiments, anolyte solution 122 comprises a same-cation salt 120 used to replenish a corresponding electrolyte cation such as K⁺, Na⁺ and/or Li⁺ or possibly organic cations (e.g., choline⁺, (CH₃)₃NCH₂CH₂OH⁺ such as in choline hydroxide electrolyte, HOCH₂CH₂N(CH₃)₃OH). Same-cation salt 120 may be introduced once into anolyte solution 122 or be replenished when needed, e.g., from salt unit 121 configured to add same-cation salt 120 to anolyte solution 122 when required. Examples for same-cation salts comprise cations such as K⁺, Na⁺ and/or Li⁺, and anions such as nitrates, carbonates, bicarbonates, hydrogen or dihydrogen phosphates and/or hydrogen sulphates.

In some embodiments, the same-cation salts may comprise hydrogen carbonates such as potassium bicarbonate (KHCO₃), sodium bicarbonate (NaHCO₃), or lithium carbonate (Li₂CO₃); or hydrogen phosphates such as potassium dihydrogen phosphate (KH₂PO₄), dipotassium hydrogen phosphate (K₂HPO₄), sodium dihydrogen phosphate (NaH₂PO₄), disodium hydrogen phosphate (Na₂HPO₄), lithium phosphates (Li₃PO₄), potassium hydrogen sulphate (KHSO₄), sodium hydrogen sulphate (NaHSO₄), or lithium hydrogen sulphate (LiHSO₄) —depending on the cation used in the electrolyte.

It is noted that the addition of the same-cation salt counters cation movement out of the anolyte solution due to acidification thereof as a result of the ATH precipitation—and decouples the cation concentration from the pH in the anolyte solution. The addition of cation prevents the process from halting midway due to the decreasing pH and lack of cations, and thereby improves process efficiency, allows complete regeneration of the SE, and maintains the advantageous gradient of cation across the membrane throughout the whole process.

Advantageously, the addition of same-cation salt 120 maintains the concentration of the respective cation (e.g., K⁺, Na⁺ and/or Li⁺) high during the electrolyte regeneration process—as the respective cation diffuses through separator 115 (that hinders OH diffusion from catholyte solution 128 to anolyte solution 122) to catholyte solution 128 and is consumed to yield regenerated electrolyte 109. Same-cation salt 120 thus provides a constant gradient of the same cations that support its continuous diffusion to catholyte solution 128 even as SE is depleted in anolyte solution 122. Moreover, the anions of same-cation salt 120 contribute to maintain a stable anolyte pH (e.g., <12 such as at ca. 10-11) that keeps an optimal rate of ATH precipitation. Catholyte solution 128 may reach a KOH concentration which is similar or close to the required concentration of regenerated electrolyte 109, e.g., pH>14. For example, 20-30 wt % of catholyte solution 128 may be removed to yield regenerated electrolyte 109 at the end of the process and/or periodically during the process.

In certain embodiments, the alkali same-cation salt 120 comprises alkali metal ions (or organic ions such as choline) and monovalent or multivalent anions such as CO₃²⁻, HCO₃⁻, Cl⁻, Br⁻, I⁻, NO₃⁻, SO₄², phosphate, citrate, formate or acetate. Specific non-limiting examples for same-cation salt 120 comprise any of: alkali-carbonate, alkali-bicarbonate or a combination thereof, e.g., sodium carbonate, sodium bicarbonate, potassium carbonate, potassium bicarbonate or a combination thereof. In certain embodiments, the disclosed methods and systems may further comprise adding a conjugate (such as the conjugate acid of the anion of the same-cation salt) into the anolyte solution. In non-limiting examples, the conjugate acid may comprise any of H₂CO₃, HCO₃⁻, HPO₄²⁻, H₂PO₄⁻, HSO₄⁻, formic acid, citric acid, hydrogen citrate, dihydrogen citrate, acetic acid, etc.

In certain embodiments, anode 112 may be in the form of a thin plate, e.g., about 0.05 mm to 2.5 mm thick, may exhibit low oxygen evolution over-potential, and may be made of metals such as titanium, nickel or silver, possibly coated by metal oxides such as platinum oxide, or possibly silver oxide, ruthenium oxide or nickel cobalt oxide and.

In certain embodiments, cathode 118 may comprise of a gas diffusion electrode and/or an air electrode as described in U.S. Pat. No. 8,142,938 and incorporated herein by reference in its entirety and/or any air electrode utilizing electrode active material particles that promote oxygen reduction such as silver/zirconium oxide particles, platinum particles, manganese dioxide particles, etc.

In certain embodiments, separator 115 may comprise membrane(s) that allow the transport of alkali cation (e.g., K⁺, Na⁺ and/or Li⁺) from the anolyte solution across the membrane to the catholyte solution. Cation-exchange membranes may have negatively charged groups affixed on their surface, and may be configured to exhibit good mechanical strength, low ionic resistance to cations, high ionic resistance to anions and good chemical stability in an alkaline environment.

In certain embodiments, the anodic and cathodic compartments of anolyte solution 122 and catholyte solution 128, respectively, may comprise temperature measuring device(s) (e.g., any of thermometer(s), thermocouple(s) or any other device for measuring temperature) immersed in the respective electrolyte solutions, in communication with controller 116 and configured to detect and report temperature changes occurring during the electrolysis. The measurement of the temperature may be used to generate an automatic feedback signal triggering the activation of heating/cooling means once the measurement of the temperature indicates a value outside a working range. For example, controller 116 may be configured to maintain the operational temperature within the range of 15° C. to 95° C.

In operation, anolyte solution 122 may comprise of an aqueous solution of an alkali salt of a hydroxide complex anion, e.g., of the formula [M(OH)ₙ]⁻ or [M(OH)ₙ]²⁻, such as K[Al(OH)₄] obtained from a spent electrolyte solution (either cloudy with precipitated metal hydroxide or clear following solid/liquid separation). In non-limiting examples, the concentration of anolyte solution 122 may be in the range of 20-250 gr Al/liter. In non-limiting examples, the concentration of anolyte solution 122 may be in the range of 1-7M Al. Catholyte solution 128 may comprise of an alkali hydroxide solution with initial concentration (Cᵢ) of, e.g., over 1 wt %, over 3 wt %, between 1% and 30 wt %, or between 5% to 20 wt %. In batch-wise operation, the electrolysis may be terminated after the final concentration of the alkali hydroxide at the cathodic side (C_{f}) is increased by at least 1% (C_{f}≥Cᵢ+1) and/or at least 10 wt %, for example, between 10 wt % and 40%. Upon reaching the desired concentration, catholyte solution 128 may be removed from the cathodic side and transferred to a storage reservoir 109. In certain embodiments, stored concentrated alkali hydroxide solution may be diluted with fresh water to form a starting catholyte solution for the next production cycle.

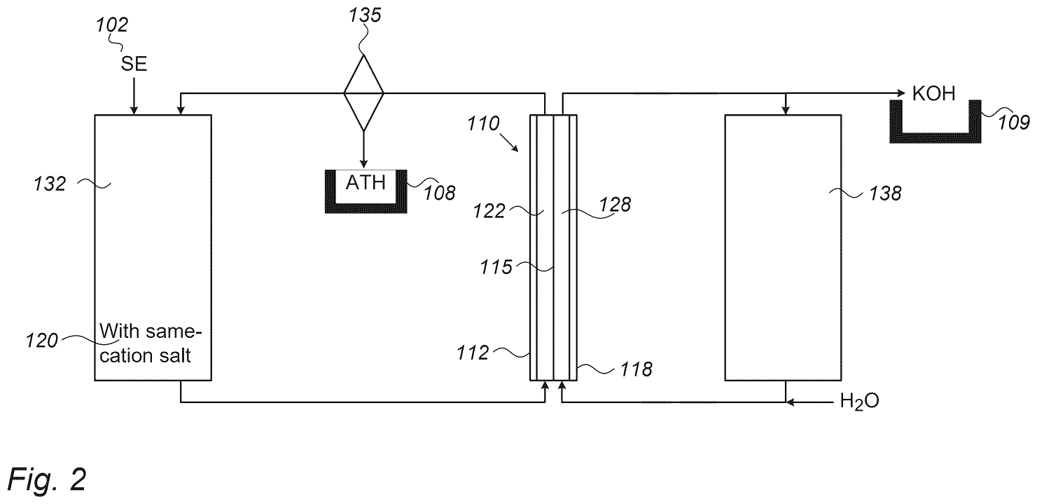

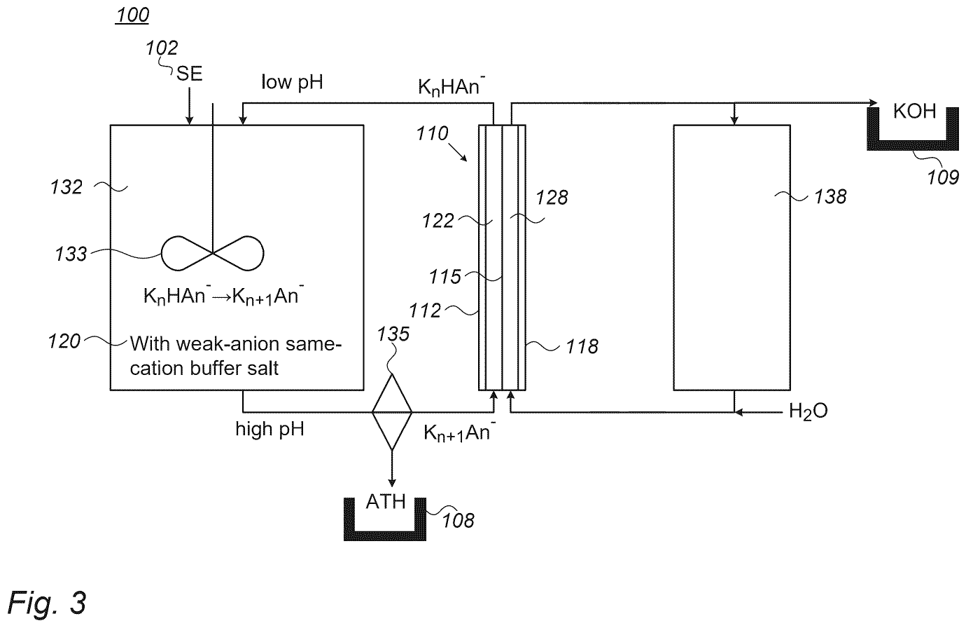

FIGS. 2 and 3 are high-level schematic illustrations of systems 100 for regenerating spent electrolyte, according to some embodiments of the invention. While system 100 may be operated in batches, e.g., as illustrated in FIG. 1, FIG. 2 illustrates schematically configurations of system 100 for implementing continuous electrolyte regeneration and ATH precipitation. System 100 may further comprise an anolyte tank 132 and a catholyte tank 138 in fluid communication with, and for circulating corresponding solutions to and from anolyte solution 122 and catholyte solution 128 of electrolysis unit 110, respectively. Anolyte tank 132 may receive anolyte solution from which ATH is precipitated and filtered, e.g., by filter 135 or any other solid/liquid separation means (involving e.g., filtering and/or centrifugation), receive SE and deliver anolyte solution, while catholyte tank 138 may receive catholyte solution from which regenerated electrolyte (e.g., KOH) is removed and deliver catholyte solution, possibly with addition of water as needed. System 100 may be configured to circulate continuously the anolyte and catholyte solutions to and from respective anolyte and catholyte tanks 132, 138. ATH collection unit 108 and regenerated electrolyte collection unit 109 may be positioned after electrolysis unit 110 and before respective anolyte and catholyte tanks 132, 138.

In various embodiments anolyte and/or catholyte tanks 132, 138, respectively may be stirred or agitated, e.g., continuously, to maintain homogenous solutions in them, as illustrated schematically in FIG. 3 by stirrer 133.

In certain embodiments, anolyte tank 132 may be configured as a salt tank 132 into which same-cation salt 120 is added and in which same-cation salt 120 is monitored, in physical separation from (and while maintaining liquid communication with) anolyte solution 122. Advantageously, as ATH precipitation is kinetically slow, separating ATH precipitation from KOH regeneration enables adjusting solution quantities and flow rates in a way that does not limit electrolyte regeneration by the rate of ATH precipitation and decouples the rates of the processes temporally, in addition to their spatial separation.

Correspondingly, in the following, the terms “anolyte tank” and “salt tank” are used interchangeably. In certain embodiments, ATH precipitation and filtration may be carried out in and/or after salt tank 132, spatially decoupling ATH precipitation and electrolysis.

In certain embodiments, using a buffering salt (e.g., having a weak base as anion) as same-cation salt 120, both helps maintain required pH values of the anolyte solution and enables precipitating ATH before the anolyte solution enters electrolysis unit 110, to simplify ATH removal as illustrated in FIG. 3. Correspondingly, ATH collection unit 108 may be positioned after anolyte tank 132 and before electrolysis unit 110. Examples for buffering salts comprise cations such as K⁺, Na⁺ and/or Li⁺ and anions such as phosphates and/or carbonates. In the non-limiting example illustrated in FIG. 3, buffering salt 120 is denoted schematically as having a K cation (as a non-limiting example, for regenerating corresponding KOH electrolyte) and undergoing the reaction KₙHAn⁻→Kₙ₊₁An⁻, following which the pH rises, ATH precipitates and the buffering salt is delivered into anolyte solution 122 as Kₙ₊₁An⁻ and after the electrolysis back to salt tank 132 as KₙHAn⁻. For example, in the case of carbonates, KₙHAn⁻→Kₙ₊₁An⁻ may denote the neutralization reaction (not balanced) of potassium bicarbonate (KHCO₃) to potassium carbonate (K₂CO₃). For example, certain embodiments comprise adding SE to KHCO₃ as a separate step (e.g., neutralization reaction) before the electrochemical regeneration described herein.

In some embodiments, the electrolysis processes may be conducted for any of about 10 h, for about 15 h, or for about 20 h. In some embodiments, electrolysis process time (e.g., the duration of passing current through membrane electrolysis cells 110, the duration of applying current to the cells, the duration of forcing current through the cells, the duration of occurrence of the oxidation/reduction reactions, enabling electrical current conduction, etc.) may range between 1 h and 20 h, between 5 h and 15 h, between 1 h and 50 h, between 1 h and 100 h, between 0.1 h and 100 h, between 1 minute and 5 h, between 10 h and 30 h, between 1 minute and 1 h, between 2 h and 25 h, between 10 h and 75 h, etc.

In some embodiments, the electrolysis process may be conducted at any of room temperature, an elevated temperature or at a temperature lower than room temperature. In some embodiments, the processes may be initially conducted at room temperature, followed by temperature elevation, e.g., to any of the temperature ranges of 30° C.-40° C., 25° C.-55° C., 20° C.-30° C., 25° C.-65° C., 25° C.-80° C., etc. In some embodiments, the electrolysis process may be started at a temperature range of any of 5° C.-10° C., 10° C.-20° C., 15° C.-25° C., 20° C.-30° C., 30° C.-40° C., 40° C.-50° C., 50° C.-60° C., 10° C.-80° C., 60° C.-80° C., and 80° C.-100° C. In some embodiments, the electrolysis may be temperature-controlled and kept within a desired range, maintained e.g., by controller 116 and cooling/heating devices (e.g., water cooling devices).

In some embodiments, the electrolysis process may be conducted at a current density of any of 100 mA/cm², 50 mA/cm² or at any of the ranges 10 mA/cm²-50 mA/cm², 50 mA/cm²-100 mA/cm², 10 mA/cm²-500 mA/cm², 25 mA/cm²-75 mA/cm², 50 mA/cm²-250 mA/cm², 50 mA/cm²-150) mA/cm², 150-300 mA/cm², 300-400 mA/cm², and 400-600 mA/cm². In some embodiments, the volume of the catholyte solution, the anolyte solution or of a combination thereof used for the electrolysis process may be in any of the ranges 100-150 cc, 100 cc-200 cc, 50 cc-150 cc, 20 cc-200 cc, 75 cc-125 cc, 10 cc-100 cc, 100 cc-1000 cc, 100 cc-500 cc, 500 cc-1000 cc or possibly larger volumes of multiple liters, depending on the industrial implementation.

In some embodiments, the initial KOH anolyte solution concentrations before and after electrolysis may be any of: about 30% and about 15%, respectively, or in any of the ranges of 25%-30% (initial) and 15%-20% (final), 25%-30% (initial) and 10%-20% (final), 25%-35% (initial) and 10%-20% (final), 25%-45% (initial) and 10%-25% (final), 20%-40% (initial) and 5%-20% (final), 15%-20% (initial) and 5%-10% (final), 15%-50% (initial) and 5%-25% (final), 15%-25% (initial) and 5%-15% (final), 10%-50% (initial) and 1%-30% (final), 10%-20% (initial) and 1%-5% (final), 5%-15% (initial) and 1%-50% (final).

In some embodiments, the concentration of the same-cation salt may be high, e.g., above 1M, above 5M, above 8M, above 10M etc., or may be the highest possibly concentration in the system in order to maintain a K⁺ gradient at high KOH concentrations in catholyte solution 128 (e.g., ca. 8M). In various embodiments, the same-cation salt may be added as solid or as solution, and in a range of appropriate temperatures, e.g., accommodated to the anolyte solution temperature or differing from it, and may be used to regulate the anolyte solution temperature. The amount of added salt may be monitored and controlled by controller 116, e.g., depending on various process parameters such as weights of concentrations of process components and/or electrical parameters such as conductivity, voltage drop, etc. In some embodiments, the same-cation salt may further comprise acid-base conjugates such as any of H₂CO₃/HCO₃⁻, HCO₃⁻/CO₃²⁻, H₂PO₄⁻/HPO₄²⁻, HPO₄²⁻/PO₄³⁻, HSO₄⁻/SO₄²⁻, formic acid/formate, acetic acid/acetate, citric acid/dihydrogen citrate, dihydrogen citrate/hydrogen citrate and hydrogen citrate/citrate. In some embodiments, certain amounts of acids or bases may be added to control the pH, comprising cations other that the electrolyte cation and/or anions other than the anions of the same-cation salt.

In certain embodiments, electrolyte regeneration system(s) 100 may be placed in electric vehicle battery maintenance centers providing service to electric vehicles (EVs) powered by metal/air batteries with alkaline electrolyte. On arrival at the maintenance center, at least a portion of SE may be drained from the electric vehicle and subjected to regeneration as disclosed herein. Regenerated electrolyte and/or fresh electrolyte may then be fed to the electric vehicle (e.g., to a reservoir associated with the respective batteries). Corresponding pumping unit(s) may be configured to facilitate SE transfer from EV to system 100 and regenerated/fresh electrolyte transfer back to the EV. Corresponding units for estimating the composition of received SE and provided regenerated/fresh electrolyte may be configured in association with system 100 to adjust the implemented regeneration process and electrolyte provision according to specified requirements. Gas outlets, e.g., for oxygen and electrolyte temperature regulation means may be part of system 100 as well, possibly controlled by controller 116. Water may also be supplied under control of controller 116 to dilute the regenerated electrolyte (and/or possibly the spent electrolyte).

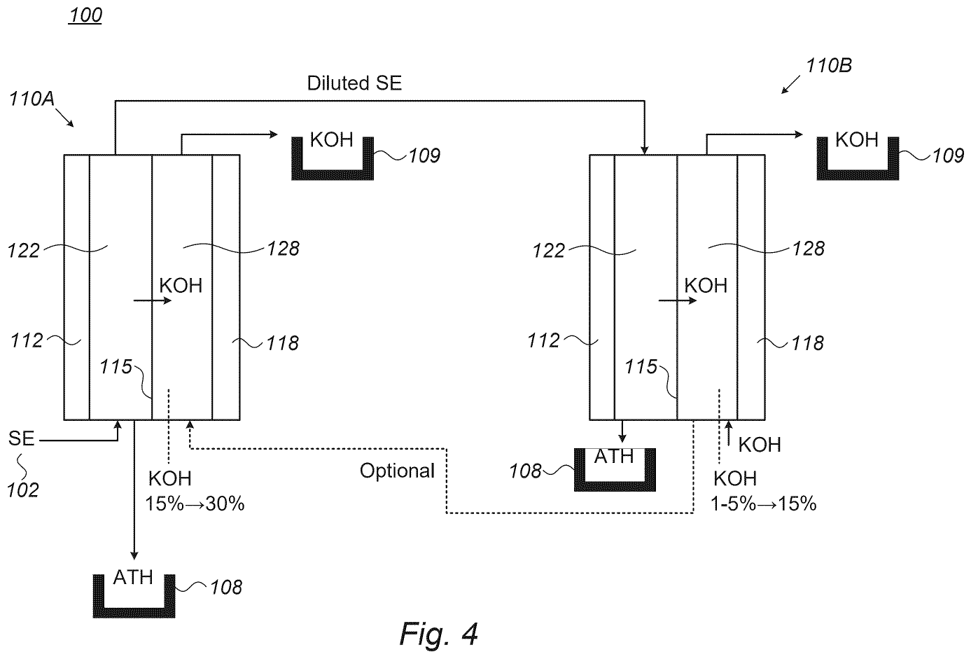

FIG. 4 is a high-level schematic illustration of multi-cell systems 100 for regenerating spent electrolyte by electrolysis, according to some embodiments of the invention.

In certain embodiments, system 100 may comprise multiple electrolysis units 110A, 110B, etc., configured to implement a multi-step electrolysis process over step-wise decreasing electrolyte concentrations, designed to enhance the efficiency of the separation of e.g., KOH from alkali aluminate solution carried out in the membrane electrolysis cell. During a single electrolysis process comprising one membrane cell, the concentration of KOH in the catholyte solution gradually increases and its concentration in the anolyte solution decreases. After some electrolysis time, the concentration gradient (high concentration in the catholyte solution and low concentration in the anolyte solution) reduces the efficiency of K⁺ ion passage from the anolyte solution to the catholyte solution. In order to overcome this effect, the spent electrolyte may be introduced as the anolyte solution to the anode compartment of a first electrolysis cell 110A. The KOH concentration of the spent electrolyte may be e.g., around 30%. As a catholyte solution, a KOH solution of approximately 15% may be introduced. The electrolysis process may be started by passing current through the cell. During electrolysis, K⁺ ions are transferred from the anolyte solution to the catholyte solution through the cell membrane. After some electrolysis time, the KOH concentration in the anolyte solution reduces from approximately 30% to approximately 15%. At the same time, the KOH concentration in the catholyte solution increases from approximately 15% to approximately 30%. At this point, the catholyte solution can be used as a regenerated electrolyte and can be removed, e.g., transferred to storage or to a corresponding battery. The anolyte solution (now of KOH concentration of approximately 15%) may then be transferred to the anode compartment of a second electrolysis cell 110B forming the anolyte solution of a second cell. For the catholyte solution of the second cell, a solution comprising of KOH with a concentration of a few percent (e.g. 2%-3% KOH or 3%-5% KOH) may be introduced. This lower KOH concentration enhances the efficiency of K⁺ ion passage from the anolyte solution to the catholyte solution during electrolysis. Electrolysis may then be started in the second cell by passing current through the cell. As a result of the current supplied. K⁺ ions are transferred from the anode compartment to the cathode compartment through the membrane. Accordingly, KOH concentration in the catholyte solution increases (e.g., from 1-5% to approximately 15%) while KOH concentration in the anolyte solution decreases (e.g., from 15% to approximately 1-5%). This step of the process allows the extraction of more KOH from the spent electrolyte solution. The anolyte solution resulting from the second cell electrolysis may be discarded. The catholyte solution resulting from the second cell electrolysis may be transferred to the cathode compartment of the first electrolysis cell, as it has the desired KOH concentration (˜15%) for the first electrolysis process.

The two electrolysis processes in two electrolysis cells 110A, 110B may be carried out serially and for various time periods. After the completion of each first electrolysis process in cell 110A, the first KOH concentrated catholyte solution which contains regenerated electrolyte may be stored, transferred to the battery, transferred to an electrolyte reservoir which is part of the battery and/or to any other electrolyte reservoir. The catholyte solution used for the second electrolysis process in unit 110B may be made from KOH and water in certain embodiments and/or may be the washing water of solids/wetted solids comprising KOH in certain embodiments. Any number of electrolysis processes may be used in the cascade approach described above, e.g., two or more cells. Any embodiments described herein for single electrolysis cell 110 may be implemented in any of the multiple cells.

In certain embodiments, additional processes may be carried out in parallel and solutions from parallel process may be combined.

In certain embodiments, the two-step electrolysis process may be conducted in a single electrolysis cell 110 by introducing the spent electrolyte as the anolyte solution of the cell, placing an alkali hydroxide solution in the catholyte cell, and performing a first electrolysis step by passing current through the cell, with electrolysis causing the increase of the alkali hydroxide concentration in the catholyte solution. During this first electrolysis step, the alkali hydroxide concentration in the anolyte solution decreases and following this first electrolysis step, the catholyte solution from the cell may be removed and a new catholyte solution may be introduced into the cathode compartment. The anolyte solution resulting from the first electrolysis step remains in the anode compartment. Then, the second electrolysis step may be performed by passing current through the cell, with electrolysis causing the increase of the alkali hydroxide concentration in the catholyte solution. During this second electrolysis step, the alkali hydroxide concentration in the anolyte solution further decreases, and following this second electrolysis step, the catholyte solution from the cell may be removed and a new catholyte solution may be introduced into the cathode compartment. The anolyte solution resulted from the second electrolysis step may be discarded.

In certain embodiments, system 100 may comprise, and the electrolysis process may be implemented in, a continuously operated train of numerous electrolysis cells 110, interconnected in way, allowing the counter-current flow of liquid through anodic parts of the cells in the train (anolyte solution flow), and through cathodic parts of the cells in train (catholyte solution flow). To provide such an organization of anolyte solution and catholyte solution, the outlet of the anodic compartment of cell number one in the train may be connected to the inlet of the anodic compartment of the cell number two, and so on; while the outlet of the cathodic compartment of the last cell in the train may be connected to the inlet of the cathodic compartment of the cell before last, and so on. The spent electrolyte may be fed into the inlet of the anodic compartment of the cell number one, and low-concentration alkaline solution may be fed into the inlet of the cathodic compartment of the last cell. The regenerated electrolyte may be discharged from the outlet of the cathodic compartment of the cell number one, and the low concentration alkali solution, containing aluminum compounds, may be discharged from the outlet of the last cell.

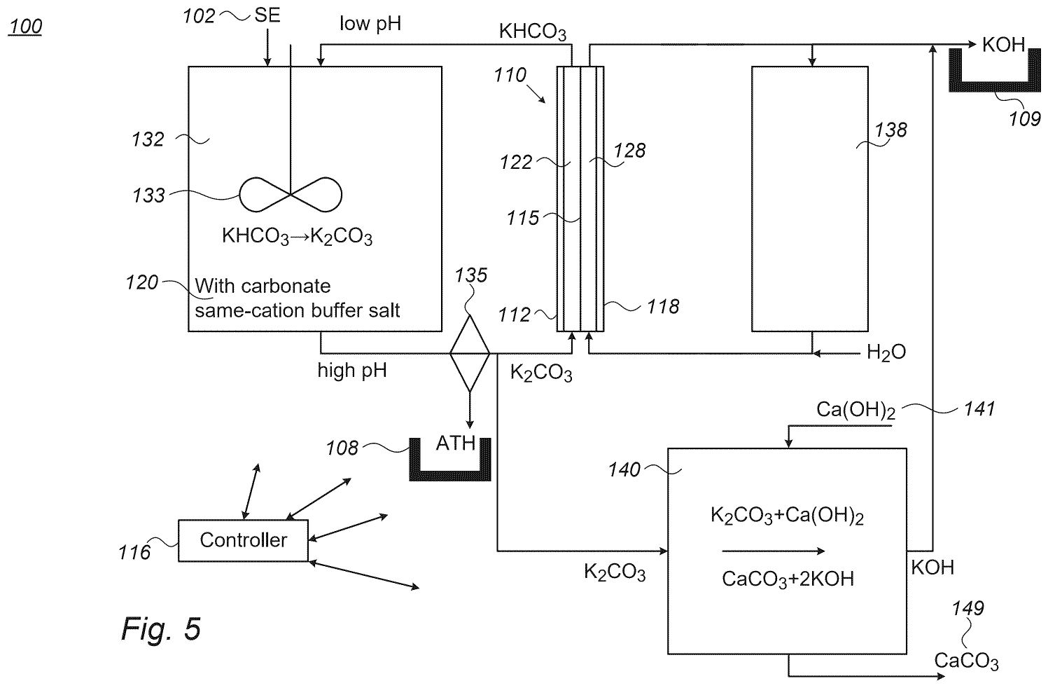

FIG. 5 is a high-level schematic illustration of system 100 for regenerating spent electrolyte by electrolysis and chemically, according to some embodiments of the invention. In the non-limiting illustration, potassium-based electrolyte is regenerated using potassium carbonates, by combining electrolysis and a chemical process. System 100 may further comprise a chemical reaction chamber 140 configured to convert calcium hydroxide (Ca(OH)₂) to calcium carbonate (CaCO₃) and being in fluid communication at least with salt (anolyte solution) tank 132. For example, chemical reaction chamber 140 may be configured to carry out the reaction K₂CO₃+Ca(OH)₂→CaCO₃+2KOH. Some of the anolyte solution, e.g., with K₂CO₃ following ATH precipitation, may be delivered into chemical reaction chamber 140 that receives calcium hydroxide and uses the potassium carbonate to produce calcium carbonate while regenerating the electrolyte. In various embodiments, the electrolytic and chemical processes of regenerating the electrolyte may be monitored and controlled to balance electrolyte regeneration according to specified requirements. In certain embodiments, calcium carbonate may then be heated to yield quicklime (CaO). In some embodiments, electrolysis may be at least partly or temporarily replaced by calcium carbonate (CaCO₃) production.

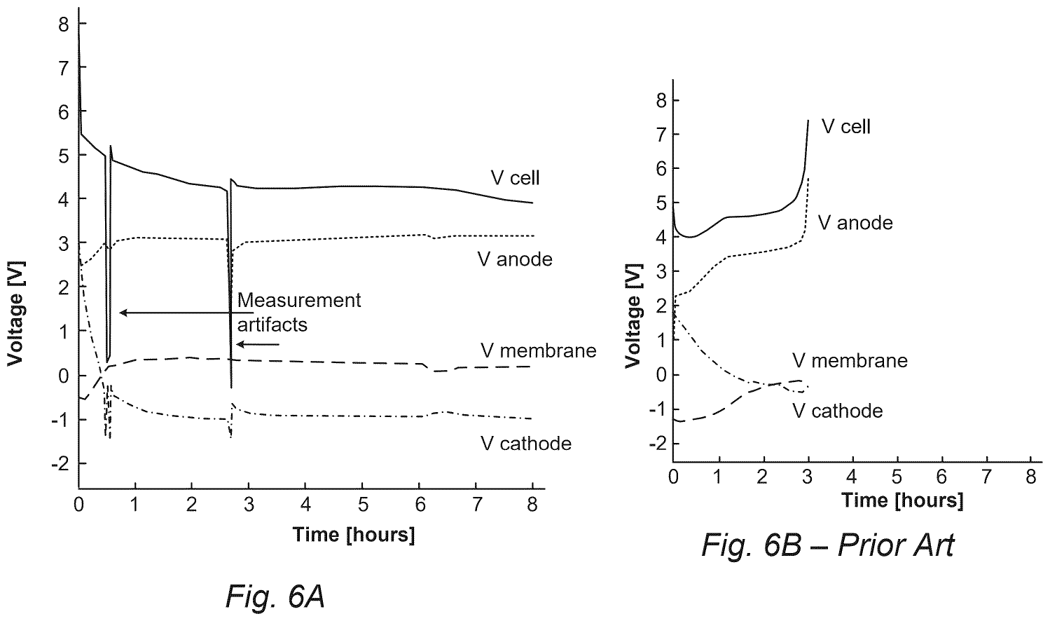

FIGS. 6A and 6B present examples for voltages across cell elements with electrolysis cell 110 operated according to some embodiments of the invention compared to prior art electrolysis, respectively. As illustrated in prior art example FIG. 6B, of operating an electrolysis process to spent electrolyte without addition of same-cation salt 120, the voltage across the cell saturates after three hours of operation, due to a steep increase in the voltage across the anode (denoted V anode) that effectively stops the regeneration process, possibly due to the dwindling of the cation gradient across the cell. In contrast, carrying the electrolysis as disclosed results in the non-limiting example presented in FIG. 6A system 100 maintains a stable and operable voltage across all cell components (anode 112, membrane 115 and cathode 118, with respective voltages V denoted) for eight hours and on-going during the whole process (it is noted that the two downwards peaks are measurement artifacts).

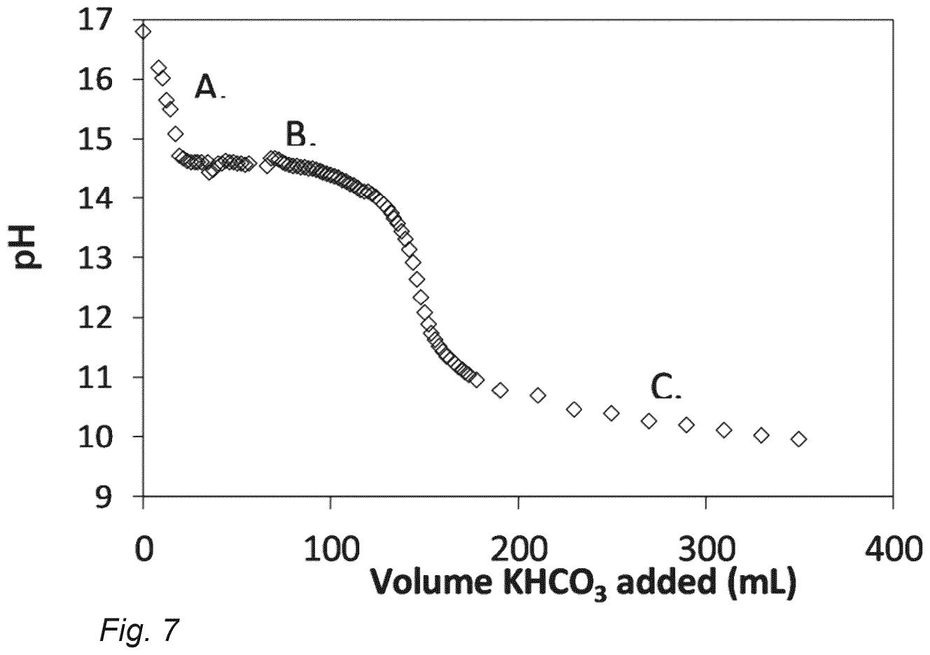

FIG. 7 provides experimental data illustrating the dependence of the ATH precipitation on the pH, according to some embodiments of the invention, as explained below in Example 6. FIG. 7 illustrates the pH transition as KHCO₃ is dispensed into the spent electrolyte, whereby region A corresponds to the neutralization of KOH, region B corresponds to the decomposition of Al(OH)₄⁻ into Al(OH)₃ and OH⁻ while region C corresponds to a solution whose pH is almost exclusively dependent on the ratio of CO₃²⁻ to HCO₃⁻.

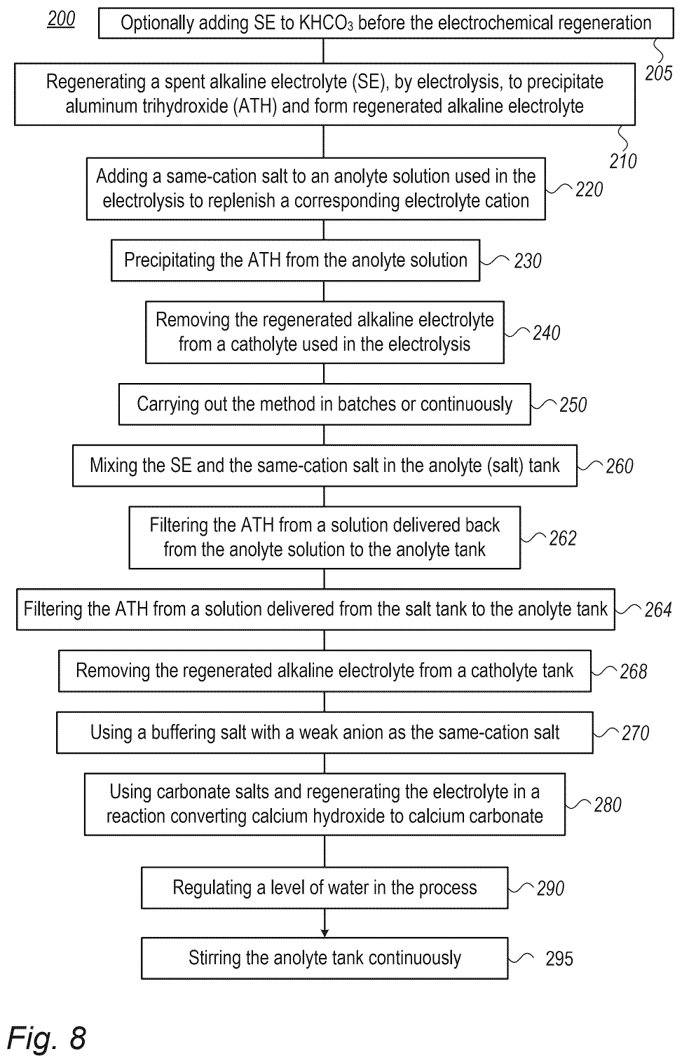

FIG. 8 is a high-level flowchart illustrating a method 200, according to some embodiments of the invention. The method stages may be carried out with respect to systems 100 described above, which may optionally be configured to implement method 200. For example, method 200 may comprise applying electrolysis to the SE in electrolysis unit 110 to precipitate the ATH and regenerate the alkaline electrolyte. In various embodiments, method 200 may comprise the following stages, irrespective of their order.

Method 200 may comprise regenerating a spent alkaline electrolyte (SE) comprising dissolved aluminum oxide hydrates from an aluminum-air battery, by electrolysis, to precipitate aluminum tri-hydroxide (ATH) and form regenerated alkaline electrolyte (stage 210), and adding a same-cation salt to an anolyte solution used in the electrolysis to replenish a corresponding electrolyte cation (stage 220). Method 200 further comprises precipitating the ATH from the anolyte solution (stage 230) and removing the regenerated alkaline electrolyte from a catholyte solution used in the electrolysis (stage 240). In various embodiments, method 200 may be carried out for consecutive batches of SE and/or continuously (stage 250).

Optionally, method 200 may further comprise adding SE to KHCO₃ as a separate step (e.g., neutralization reaction) before electrochemical regeneration stage 210 (stage 205).

In certain embodiments, method 200 may further comprise mixing the SE and the same-cation salt in an anolyte tank (or salt tank) configured to deliver the anolyte solution (stage 260), removing the regenerated alkaline electrolyte from a catholyte tank configured to deliver the catholyte solution (stage 268), and filtering the ATH from a solution delivered back from the anolyte solution to the anolyte tank (stage 262) and/or filtering the ATH from a solution delivered from the salt tank to the anolyte tank (stage 264). In certain embodiments, the same-cation salt may comprise as cations potassium and/or sodium (with the alkaline electrolyte comprising KOH, NaOH and/or LiOH), and as anions any of nitrates, phosphates and/or carbonates thereof. Method 200 may further comprise stirring the anolyte tank continuously (stage 295).

Certain embodiments comprise using a buffering salt with a weak anion as the same-cation salt (stage 270), e.g., having phosphates and/or carbonates as the anions. In case the buffering salt comprises carbonates, method 200 may further comprise using the carbonate salts to regenerate the electrolyte in a reaction converting calcium hydroxide to calcium carbonate (stage 280), e.g., to regenerate the electrolyte in a corresponding chemical reaction.

Any of disclosed methods 200 may comprise regulating a level of water in the process (stage 290), e.g., by adding water to the catholyte solution when needed.

In various embodiments, elements from FIGS. 1-8 may be combined in any operable combination, and the illustration of certain elements in certain Figures and not in others merely serves an explanatory purpose and is non-limiting.

### EXAMPLES

In the following, non-limiting examples for the preparation and operation of systems 100 and methods 200 are provided. These examples illustrated the applicability of disclosed methods 200 and systems 100, and do not limit the scope of the invention.

### Example 1—System Set-Up

The system contains two compartments (made from PMMA, one for anolyte solution and one for catholyte solution, 2.5 L each. The size of each tank is 10×10×16 cm and a membrane separates the two compartments). Peristaltic pumps (Hontile Industrial Co. LTD) enable the circulation of electrolyte through the electrolysis membrane cell. The electrolysis cell is connected to a power source (Mancon Hcs 3042) where the voltage/current is computer recorded and the pH at the anolyte solution compartment is consistently monitored as well.

A separate beaker with 100 ml of filtered spent electrolyte (SE) is placed adjacent the anolyte solution compartment. The spent electrolyte composition is as followed—108 g/l KOH, 857 g/l KAl(OH)₄ and 500 g/l H₂O. The SE is dripped into the anolyte solution with the aid of peristaltic pump as needed.

The anolyte solution compartment was filled with 1500 ml of 2.5M K₂CO₃ (5N, Sigma Aldrich>98%) solution (pH˜12.6) and the catholyte solution compartment was filled with 1500 ml of 20% KOH solution (w/w, ˜5N, GADOT Ltd.).

During potential application a sample (1 ml) is taken (each 40 minutes) from the catholyte solution compartment for KOH concentration analysis conducted with an automated titrator (Metrohm, Titrotherm 859).

### Example 2—Electrolysis Membrane Cell Assembly

Nickel plate of 99.6% purity serves as an anode, the cathode is an air cathode produced by Phinergy™. The membrane is a commercial N551WX K⁺ Nafion membrane. Zinc wires wrapped in Teflon sleeves are placed adjacent to both sides of the membrane. The potential of the anode and the cathode (with respect to Zn/ZnO) is consistently recorded.

### Example 3—Inspected Parameters and Experiment Conditions I

The cell was operated under constant current of 100 mA/cm² (normalized to membrane surface area) at room temperature. At first the anolyte solution pH was adjusted into lower values (˜10.5) prior to SE addition. Addition of SE was manually adjusted to maintain pH between 9-10.5.

The parameters that were evaluated in this experiment were: Potentials (vs. Ref. electrode) of the anode and cathode; iR drop caused by the membrane (and by solution resistance); Caustic current efficiencies (CCE); and Water transport upon potential application (electro-osmotic drag coefficient—in ml/mol K⁺ or mol/mol K⁺).

In a further experiment, both with a static electrolysis membrane cell and the system described above, we were able to demonstrate 100% CCE. Moreover, SE was dripped into a portion taken from the anolyte solution compartment separately (i.e. not during potential application or the anolyte solution compartment), and the outcome ATH was analyzed by DLS to give particle size distribution.

The experiment has shown that the pH range was maintained after the SE was added to the anolyte solution, and kept stable around pH=15 (in the sense that after a ten-fold dilution of the anolyte solution, the measured pH was 14). Moreover, the potential-time profile remained quite the same before and after SE addition and the potential of the SE generator remained constant during application. The water transport via the membrane under these conditions was about 50 ml/mol K.

### Example 4—Inspected Parameters and Experiment Conditions II

To calculate the caustic charge efficiency of this process, a static small electrolysis cell was occupied. The membrane (Nafion N551WX) size was about ˜12 cm². The volume of the anolyte solution and catholyte solution compartments was 100 ml each. Similar to the experiment shown in example 3 above, the cathode was an air cathode (Phinergy) and the anode was a 1 mm nickel plate 99.6%. A current of 100 mA/cm² (with respect to membrane surface area) was applied. The anolyte solution composition was potassium carbonate/bicarbonate 2.5N and the catholyte solution concentration was 20% KOH w/w (weight/weight). The current application lasted one hour at room temperature. At the end of the experiment aliquots from the catholyte solution were taken for KOH concentration analysis and the caustic current efficiency (η) was calculated according to the relation η (%)=100·Δn_{KOH(catholyte)}/(I·t/F), with Δn_{KOH(catholyte)} denoting the changes in KOH amount in the catholyte compartment (in moles), I denoting the current (in A), t denoting the time, in seconds, and F being the Faraday constant. The changes in KOH amount in the catholyte compartment was calculated by subtracting the multiplication of the initial concentration of KOH by its initial volume from the multiplication of final KOH concentration by its final volume. The caustic charge efficiency was found to be 100%.

### Example 5—Inspected Parameters and Experiment Conditions III

A portion of 100 ml from anolyte solution from the first experiment (pH 9.2, ˜2.5N potassium carbonate/bicarbonate) was removed and placed into a separate glass beaker. A filtered spent electrolyte (108 g/l KOH, 857 g/l KAl(OH)₄ and 500 g/l H₂O) was titrated slowly into the glass beaker where the temperature was maintained between 55-65° C. The titration was ceased after the pH reached 8.2. The obtained ATH precipitants were analyzed by direct light scattering technique. The particle size distribution of the ATH precipitants was around 10 μm, ranging between 1-60 μm.

### Example 6—Neutralization with Buffering Agent

In certain embodiments comprise SE may be added to KHCO₃ and/or KHCO₃ may be added to SE as a separate step (e.g., neutralization reaction) before the electrochemical regeneration.

To illustrate the dependence of the ATH precipitation from a buffered salt solution, a portion of 50 ml of spent electrolyte (101 g/l KOH, 1017 g/l KAl(OH)₄ and 479 g/l H₂O) was placed into a glass beaker and magnetically stirred at room temperature. A section of 1 mm i.d. PTFE capillary tubing was fixed at the top of the beaker containing the spent electrolyte while the opposite end was connected to a syringe infusion pump (Harvard Apparatus, model number 2400-006) equipped with a syringe containing an aqueous, saturated solution of KHCO₃. The pump was then configured to dispense the saturated KHCO₃ at a flow rate of 2 ml/min. Finally, a pH probe (Fisher Scientific, Accumet AR50) was introduced into the glass beaker to monitor the electrolyte neutralization process. FIG. 7 illustrates the pH transition as KHCO₃ was dispensed into the spent electrolyte, whereby region A corresponds to the neutralization of KOH, region B corresponds to the decomposition of Al(OH)₄⁻ into Al(OH)₃ and OH⁻ while region C corresponds to a solution whose pH is almost exclusively dependent on the ratio of CO₃²⁻ to HCO₃⁻.

### Example 7—Aluminum Content in Neutralized Electrolyte

In a replicate experiment to Example 6, aliquots of the liquid portion were collected at select pH intervals, filtered and analyzed for elemental composition via inductively coupled plasma-optical emission spectroscopy (ICP-OES). The dissolved aluminum content varied as a function of pH and added KHCO₃ as summarized in Table 1.

TABLE 1
Dependence of ATH precipitation on the pH.

| | Percent of dissolved aluminum in solution |
|---|---|
| pH | removed due to pH change (%) |
| 16.25 (start) | 0% |
| 14.91 | 10.5% |
| 12.80 | 99.4% |
| 9.84 | 99.95% |

Advantageously, disclosed systems 100 and methods 200 overcome limitations of prior art methods of treating spent electrolyte, such as U.S. Patent Application Publications Nos. 2012/0292200, US2013/0048509, 2016/0149231 that teach various approaches of membrane electrolysis that are limited by the available potassium concentration gradient, the changing pH gradients, required modifications of the SE feed and/or by metal ion concentration gradients—among other features by the addition of the same-cation salt to the anolyte solution used in the electrolysis to replenish the corresponding electrolyte cation.

Advantageously, disclosed systems 100 and methods 200 overcome limitations of prior art methods of treating spent electrolyte, such as U.S. Pat. Nos. 9,711,804 and 5,198,085, by adding a same-cation salt that includes the same cation as the spent alkaline electrolyte but does not include aluminates—to replenish the corresponding electrolyte cations (e.g., K⁺, Na⁺ and/or Li⁺). Furthermore, disclosed systems 100 and methods 200 maintain the low pH (high [H⁺]) of the anolyte solution to promote precipitation of the aluminum hydroxides, while compensating for the resulting movement of the cations into the catholyte as a result of the low pH—by the adding same-cation salt into the anolyte solution. Hence, by adding the same-cation salt and avoiding the addition of aluminates—the rising of the pH is prevented, the rate of cation transfer from the anolyte into the catholyte is maintained and the precipitation of aluminum hydroxides is enhanced. Disclosed systems 100 and methods 200 thus effectively decouple maintaining the low pH (required for precipitation of aluminum hydroxides) from the otherwise resulting reduction in cation concentration in the anolyte, while maintaining the advantageous gradient of cation across the membrane throughout the whole process—by adding to the anolyte solution the same-cation salt that includes the same cation and does not include aluminate anions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system comprising:
an electrolysis unit comprising an anode with anolyte solution and a cathode with catholyte solution, separated by a cation-selective separator, and a controller configured to carry out an electrolysis process in the electrolysis unit;
a spent alkaline electrolyte (SE) supply configured to supply SE that comprises an electrolyte cation and dissolved aluminum oxide hydrates from an aluminum-air battery, to the anolyte solution,
wherein the anolyte solution comprises a same-cation salt that includes the same electrolyte cation as in the SE and does not include aluminates, and is used to replenish the corresponding electrolyte cation, and
wherein the electrolysis unit is configured to precipitate aluminum tri-hydroxide (ATH) and form regenerated alkaline electrolyte by electrolysis of the SE;
an ATH collection unit configured to receive the precipitated ATH from the anolyte solution; and
a regenerated electrolyte collection unit configured to receive the regenerated alkaline electrolyte from the catholyte solution,
wherein the addition of the same-cation salt counters cation movement out of the anolyte solution due to acidification thereof as a result of the ATH precipitation.

2. The system of claim 1, further comprising a salt unit configured to add the same-cation salt to the anolyte solution when required.

3. The system of claim 1, further comprising an anolyte tank in fluid communication with the anolyte solution and a catholyte tank in fluid communication with the catholyte solution, wherein the system is configured to circulate continuously the anolyte solution and the catholyte solution to and from the respective anolyte and catholyte tanks.

4. The system of claim 3, wherein the ATH collection unit and the regenerated electrolyte collection unit are positioned after the electrolysis unit and before the respective anolyte and catholyte tanks.

5. The system of claim 3, wherein:
the anolyte tank is stirred continuously,
the same-cation salt is a buffering salt with a weak base as an anion, and
the ATH collection unit is positioned after the anolyte tank and before the electrolysis unit, and the regenerated electrolyte collection unit is positioned after the electrolysis unit and before the catholyte tank.

6. The system of claim 5, wherein the same-cation salt comprises as anions—carbonates, bicarbonates, hydrogen or dihydrogen phosphates and/or hydrogen sulphates.

7. The system of claim 6, wherein the same-cation salt comprises carbonates and further comprising a chemical reaction chamber configured to convert calcium hydroxide to calcium carbonate, wherein:
the chemical reaction chamber is in fluid communication at least with the anolyte tank, and
some of the regenerated electrolyte is regenerated in the chemical reaction chamber.

8. A method of operating the system of claim 1, the method comprising:
applying electrolysis to the SE in the electrolysis unit to precipitate the ATH and regenerate the alkaline electrolyte, and
adding the same-cation salt to the anolyte solution used in the electrolysis to replenish the corresponding electrolyte cation, wherein the same-cation salt includes the same electrolyte cation as the SE and does not include aluminates,
wherein the addition of the same-cation salt counters cation movement out of the anolyte solution due to acidification thereof as a result of the ATH precipitation.

9. The method of claim 8, further comprising removing the precipitated ATH from the anolyte solution and removing regenerated alkaline electrolyte from the catholyte solution used in the electrolysis.

10. The method of claim 8, carried out continuously and further comprising:
mixing the SE and the same-cation salt in an anolyte tank configured to deliver the anolyte solution,
removing the regenerated alkaline electrolyte from a catholyte tank configured to deliver the catholyte solution, and
filtering the ATH from a portion of the anolyte solution that is delivered back to the anolyte tank.

11. The method of claim 8, carried out continuously and further comprising:
mixing the SE and the same-cation salt in a salt tank configured to deliver the anolyte solution,
removing the regenerated alkaline electrolyte from a catholyte tank configured to deliver the catholyte solution, and
filtering the ATH from a solution delivered from the salt tank to the anolyte tank.

12. The method of claim 8, wherein the same-cation salt comprises as anions any of nitrates, phosphates and/or carbonates.

13. The method of claim 8, wherein the alkaline electrolyte comprises any of KOH, NaOH and LiOH, and the same-cation salt comprises correspondingly nitrates, phosphates and/or carbonates of K and Na, respectively.

14. The method of claim 13, wherein the same-cation salt is a buffering salt with a weak anion, and further comprising stirring the anolyte tank continuously.

15. The method of claim 13, wherein the same-cation salt comprises as anions—carbonates, bicarbonates, hydrogen or dihydrogen phosphates and/or hydrogen sulphates.

16. The method of claim 15, wherein the same-cation salt comprises carbonates and further comprising regenerating the electrolyte in a chemical reaction converting calcium hydroxide to calcium carbonate.

17. The method of claim 8, further comprising partly or temporarily replacing the electrolysis by chemical electrolyte regeneration in the Ca(OH)₂ to CaCO₃ conversion reaction.

18. The method of claim 8, further comprising adding KHCO₃ to the SE to before the electrochemical regeneration.
